(19) United States
(12) Patent Application Publication
(10) Pub. No.: US 2026/0038740 A1
(43) Pub. Date: Feb. 5, 2026

(54) MULTILAYER ELECTRONIC COMPONENT

(71) Applicant: SAMSUNG ELECTRO-MECHANICS CO., LTD., Suwon-si (KR)

(72) Inventors: Seung Hun KANG, Suwon-si (KR); Jae Hoon JI, Suwon-si (KR); Eun Young LEE, Suwon-si (KR); Bum Soo KIM, Suwon-si (KR); Do Hoon KIM, Suwon-si (KR); Kyung Ryul LEE, Suwon-si (KR)

(73) Assignee: SAMSUNG ELECTRO-MECHANICS CO., LTD., Suwon-si (KR)

(21) Appl. No.: 19/223,899

(22) Filed: May 30, 2025

(30) Foreign Application Priority Data
Jul. 31, 2024 (KR) 10-2024-0102021
Jan. 22, 2025 (KR) 10-2025-0009674

(51) Int. Cl. H01G 4/30; H01G 4/12

(52) U.S. Cl. CPC H01G 4/30; H01G 4/1218

(57) ABSTRACT

A multilayer electronic component includes a body including a dielectric layer and an internal electrode; and an external electrode disposed on the body, wherein the dielectric layer includes Ti, A as a donor element, and B as an acceptor element, wherein the dielectric layer satisfies 0.1<Am≤7.5 and 0.1<Bm≤7.5, where Am and Bm are the number of moles of A and the number of moles of B, relative to 100 moles of Ti included in the dielectric layer, respectively, and wherein the dielectric layer includes a central portion spaced apart from the internal electrode and an interface portion disposed between the internal electrode and the central portion, and a secondary phase including at least one of Ti or A is disposed in the interface portion.

### CROSS-REFERENCE TO RELATED APPLICATION(S)

This application claims benefit of priority to Korean Patent Application No. 10-2024-0102021 filed on Jul. 31, 2024 and Korean Patent Application No. 10-2025-0009674 filed on Jan. 22, 2025 in the Korean Intellectual Property Office, the disclosures of which are incorporated herein by reference in its entirety.

### TECHNICAL FIELD

The present disclosure relates to a multilayer electronic component.

A multilayer ceramic capacitor (MLCC), a multilayer electronic component, may be a chip-type condenser mounted on the printed circuit boards of any of various electronic products, such as an image display device, including a liquid crystal display (LCD), a plasma display panel (PDP), or the like, a computer, a smartphone, a mobile phone, or the like, serving to charge or discharge electricity therein or therefrom.

A multilayer ceramic capacitor may be used as a component of various electronic devices due to advantages thereof such as being small in size, ensuring high capacity, and being easily mounted. As various electronic devices such as computers, mobile devices, or the like have been miniaturized and implemented with high-output, demand for miniaturization and high capacitance of the multilayer ceramic capacitors has increased.

Due to limitations of permittivity and thinning of a currently commercialized barium titanate-based (BaTiO₃) dielectric material, research into novel high-k materials is being conducted.

As candidates for such novel high-k materials, research on strontium titanate (SrTiO₃), titanium dioxide (TiO₂), and the like is being conducted, but problems such as high dielectric loss, low resistivity, or the like may occur.

### LITERATURE

### [Patent Document]

(Patent Document 1) Japanese Patent Publication No. 2018-118878

### SUMMARY

An aspect of the present disclosure is to provide a multilayer electronic component having high permittivity.

An aspect of the present disclosure is to provide a multilayer electronic component having low dielectric loss.

An aspect of the present disclosure is to provide a multilayer electronic component having high resistivity.

However, the purpose of the present disclosure is not limited to the above-described contents, and it will be more easily understood in a process of explaining specific embodiments of the present disclosure.

According to some aspects of the present disclosure, a multilayer electronic component includes a body including a dielectric layer and an internal electrode; and an external electrode disposed on the body, wherein the dielectric layer includes Ti, A as a donor element, and B as an acceptor element, wherein the dielectric layer satisfies 0.1<Am≤7.5 and 0.1<Bm≤7.5, where Am and Bm are the number of moles of A and the number of moles of B, relative to 100 moles of Ti included in the dielectric layer, respectively, and wherein the dielectric layer includes a central portion spaced apart from the internal electrode and an interface portion disposed between the internal electrode and the central portion, and a secondary phase including at least one of Ti or A is disposed in the interface portion.

According to some aspects of the present disclosure, a multilayer electronic component includes a body including a dielectric layer and an internal electrode; and an external electrode disposed on the body, wherein the dielectric layer includes (Ti_{1-x-y} NbₓIn_{y})O₂ (0<x<0.1, 0<y<0.1) as a main component, and includes a central portion spaced apart from the internal electrode and an interface portion disposed between the internal electrode and the central portion, and wherein a secondary phase including at least one of NbO₂, (Nb_{0.8}Ti_{0.2})O₂, Ti₂O, or Ti₆O is disposed in the interface portion.

### BRIEF DESCRIPTION OF DRAWINGS

Some aspects, features, and advantages of the present disclosure will be more clearly understood from the following detailed description, taken in conjunction with the accompanying drawings, in which:

FIG. 1 is a cross-sectional view of a multilayer electronic component according to an embodiment of the present disclosure.

FIG. 2 is a cross-sectional view of FIG. 1, taken along line I-I′.

FIG. 3 is a cross-sectional view of FIG. 1, taken along line II-II′.

FIG. 4 is an exploded view of the body of FIG. 1.

FIG. 5 is an enlarged view of portion K1 of FIG. 2.

FIG. 6 is a graph illustrating X-ray photoelectron spectroscopy (XPS) measurement results of Comparative Example 1.

FIG. 7 is a graph illustrating XPS measurement results of Comparative Example 2.

FIG. 8 is a graph illustrating XPS measurement results of Inventive Example 1.

FIG. 9 is a graph illustrating electron paramagnetic resonance (EPR) measurement results of Comparative Example 1, Comparative Example 2, and Inventive Example 1.

FIG. 10 is a graph illustrating EPR measurement results of Comparative Example 3.

FIG. 11 is a graph illustrating X-ray diffraction (XRD) measurement results of Comparative Example 1, Inventive Example 1, and Inventive Example 2.

FIG. 12 is an image illustrating an interface of a dielectric layer of Inventive Example 2 analyzed by SEM-EDS.

FIG. 13 is an image illustrating a central portion of a dielectric layer of Inventive Example 2 analyzed by SEM-EDS.

### DETAILED DESCRIPTION

Hereinafter, some embodiments of the present disclosure will be described with reference to specific embodiments and the accompanying drawings. However, embodiments of the present disclosure may be modified to have various other forms, and the scope of the present disclosure is not limited to the embodiments described below. Further, embodiments of the present disclosure may be provided for a more complete description of the present disclosure to the ordinary artisan. Therefore, shapes, sizes, and the like, of the elements in the drawings may be exaggerated for clarity of description, and the elements denoted by the same reference numerals in the drawings may be the same elements.

In addition, in order to clearly illustrate the present disclosure in the drawings, portions not related to the description will be omitted for clarification of the present disclosure, and a thickness may be enlarged to clearly illustrate layers and areas. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawings, an X-direction may be defined as a first direction, a stacking direction, or a thickness (T) direction, a Y direction may be defined as a second direction or a length (L) direction, and a Z direction may be defined as a third direction or a width (W) direction.

### Multilayer Electronic Component

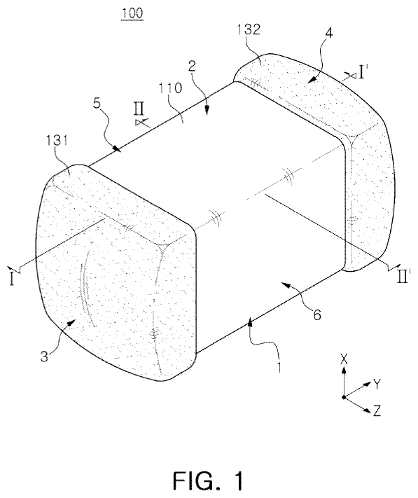

FIG. 1 is a cross-sectional view of a multilayer electronic component according to an embodiment of the present disclosure.

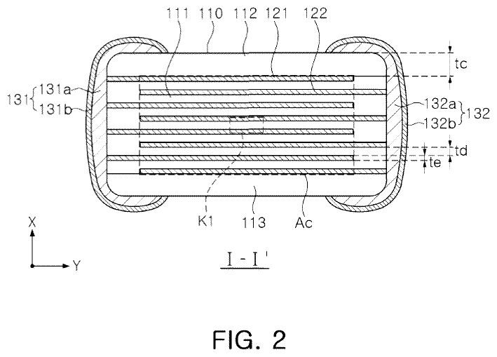

FIG. 2 is a cross-sectional view of FIG. 1, taken along line I-I′.

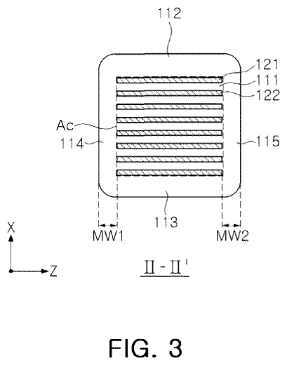

FIG. 3 is a cross-sectional view of FIG. 1, taken along line II-II′.

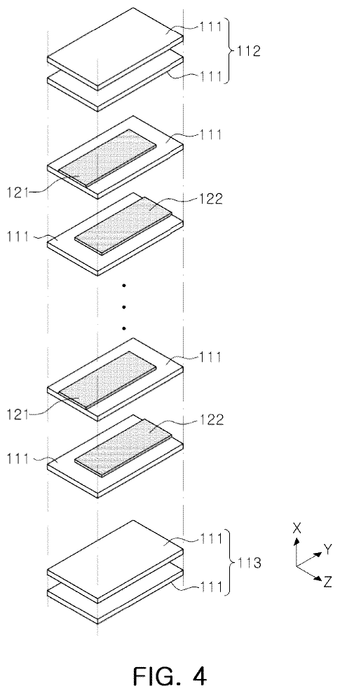

FIG. 4 is an exploded view of the body of FIG. 1.

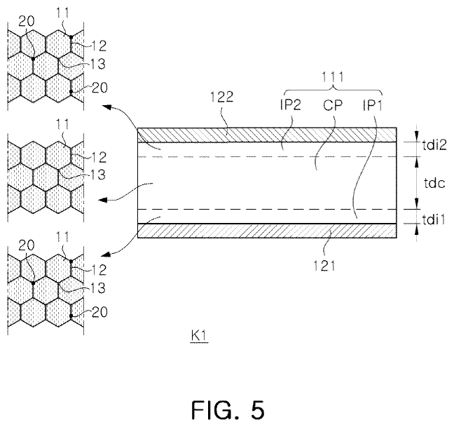

FIG. 5 is an enlarged view of portion K1 of FIG. 2.

Hereinafter, a multilayer electronic component 100 according to some embodiments of the present disclosure will be described in detail with reference to FIGS. 1 to 5. In addition, a multilayer ceramic capacitor (hereinafter referred to as ‘MLCC’) will be described as an example of a multilayer electronic component, but the present disclosure is not limited thereto and may be applied to various multilayer electronic components using a ceramic material, such as an inductor, a piezoelectric element, a varistor, a thermistor, or the like.

A multilayer electronic component 100 according to some embodiments of the present disclosure includes a body 110 including a dielectric layer 111 and an internal electrode (121 and 122); and an external electrode (131 and 132) disposed on the body, wherein the dielectric layer 111 includes Ti, A as a donor element, and B as an acceptor element, wherein the dielectric layer satisfies 0.1<Am≤7.5 and 0.1<Bm≤7.5, where Am and Bm are the number of moles of A and the number of moles of B, relative to 100 moles of Ti included in the dielectric layer, respectively, and wherein the dielectric layer 111 includes a central portion CP spaced apart from the internal electrode and an interface portion (IP1 and IP2) disposed between the internal electrode and the central portion, and a secondary phase 20 including at least one of Ti or A is disposed in the interface portion.

Due to limitations of permittivity and thinning of a currently commercialized barium titanate-based (BaTiO₃) dielectric material, research on novel high-K materials is being conducted. As candidates for these novel high-materials, research into strontium titanate (SrTiO₃), titanium dioxide (TiO₂), or the like is being conducted.

It is possible to improve permittivity by doping, dissolving, or substituting strontium titanate (SrTiO₃), titanium dioxide (TiO₂), or the like with a donor element or an acceptor element, but problems such as high dielectric loss, low resistivity, or the like may occur.

According to some embodiments of the present disclosure, the dielectric layer 111 may include Ti, A as a donor element, and B as an acceptor element, and a secondary phase 20 including at least one of Ti or A may be disposed in the interface portion (IP1 and IP2) of the dielectric layer, thereby improving permittivity while lowering dielectric loss and increasing resistivity.

In addition, a multilayer electronic component 100 according to some embodiment of the present disclosure includes a body 110 including a dielectric layer 111 and an internal electrode (121 and 122); and an external electrode (131 and 132) disposed on the body, wherein the dielectric layer 111 may include (Ti_{1-x-y}NbₓIn_{y})O₂ (0<x<0.1, 0<y<0.1) as a main component, and may include a central portion CP spaced apart from the internal electrode (121 and 122) and an interface portion (IP1 and IP2) disposed between the internal electrode and the central portion, and a secondary phase 20 including at least one of NbO₂, (Nb_{0.8} Ti_{0.2})O₂, Ti₂O, or Ti₆O is disposed in the interface portion (IP1 and IP2). Therefore, permittivity may be improved while dielectric loss may be reduced and resistivity may be increased.

Hereinafter, each configuration included in the multilayer electronic component 100 according to some embodiments of the present disclosure will be described.

The body 110 may have the dielectric layer 111 and the internal electrode (121 and 122) alternately stacked. Although the specific shape of the body 110 is not particularly limited, the body 110 may have a hexahedral shape or the like, as illustrated. Due to shrinkage of the ceramic powder included in the body 110 during the sintering process, the body 110 may not have a perfectly straight hexahedral shape, but may have a substantially hexahedral shape.

The body 110 may include first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first and second surfaces 1 and 2, connected to the third and fourth surfaces 3 and 4, and opposing each other in the third direction.

As a margin area in which the internal electrode (121 and 122) is not disposed overlaps on the dielectric layer 111, a step difference may be generated due to a thickness of the internal electrode (121 and 122), and edges connecting the first surface and the third to fifth surfaces and/or edges connecting the second surface and the third to fifth surfaces may have a shape contracted toward a center of the body 110 in the first direction, based on the first surface or the second surface. Alternatively, due to contraction behavior during a sintering process of the body, edges connecting the first surface 1 and the third to sixth surfaces 3, 4, 5, and 6 and/or edges connecting the second surface 2 and the third to sixth surfaces 3, 4, 5, and 6 may have a shape contracted toward a center of the body 110 in the first direction, based on the first surface or the second surface. Alternatively, to prevent chipping defects or the like, edges connecting each of the surfaces of the body 110 may be rounded by performing a separate process to round the edges, such that the edges connecting the first surface and the third to sixth surfaces and/or the edges connecting the second surface and the third to sixth surfaces may have a round shape.

To suppress a step difference caused by the internal electrode (121 and 122), when the internal electrode is cut to exposed to the fifth and sixth surfaces 5 and 6 of the body after stacking, and then a single dielectric layer or two or more dielectric layers are stacked on both side surfaces of a capacitance forming portion Ac in the third direction (width direction) to form side margin portions 114 and 115, there may be a shape in which a portion connecting the first surface and the fifth and sixth surfaces and a portion connecting the second surface and the fifth and sixth surfaces are not shrunken.

A plurality of dielectric layers 111 forming the body 110 may be in a sintered state, and boundaries between adjacent dielectric layers 111 may be integrated to such an extent that it may be difficult to identify the same without using a scanning electron microscope (SEM). The number of dielectric layers stacked does not need to be particularly limited, and may be determined in consideration of the size of the multilayer electronic component. For example, the body may be formed by stacking 400 or more dielectric layers.

In some embodiments, the dielectric layer 111 may include Ti, A as a donor element, and B as an acceptor element, and when the mole numbers of A and B relative to 100 moles of Ti included in the dielectric layer are Am and Bm, respectively, 0.1<Am≤7.5 and 0.1<Bm≤7.5 may be satisfied. Therefore, permittivity of the dielectric layer 111 may be further improved.

In some embodiments, Am and Bm may be more than 0.1, 0.5, 1, 1.5, 2, 2.5, 3, 3.5, 4, 4.5, 5, 5.5, 6, 6.7 or 7, and/or less than 7.5, 7, 6.5, 6, 5.5, 5, 4.5, 4, 3.5, 3, 2.5, 2, 1.5, 1 or 0.5. In some embodiments, Am and Bm are the same or different from each other.

When Am is 0.1 or less, there may be a concern that a permittivity improvement effect is insufficient, and when it exceeds 7.5, it may cause a defect, thereby deteriorating dielectric properties, and there may be a concern that dispersibility of a material including the donor element is reduced and agglomerated, thereby causing a side effect. In addition, it may excessively deteriorate insulation properties or cause dielectric loss (tan δ).

When Bm is 0.1 or less, there may be a concern that a permittivity improvement effect is insufficient, and when it exceeds 7.5, it may cause a defect, thereby deteriorating dielectric properties, and there may be a concern that dispersibility of a material including the acceptor element is reduced and agglomerated, thereby causing a side effect. In addition, it may cause dielectric loss (tan δ).

In some embodiments, Am and Bm may satisfy 0.2<Am+Bm≤15.0. Therefore, permittivity of the dielectric layer 111 may be further improved. In some embodiments, a sum of Am and Bm may be more than 0.2, 0.5, 1, 2, 3, 4, 5, 6, 7, 8, 9, 10, 11, 12, 13 or 14 and/or less than 15, 14, 13, 12, 11, 10, 9, 8, 7, 6, 5, 4, 3, 2, 1, or 0.5.

When the sum of Am and Bm is 0.2 or less, there may be a concern that a permittivity improvement effect is insufficient, and when it exceeds 15.0, it may cause a defect, thereby deteriorating dielectric properties, and there may be a concern that dispersibility of a material including the donor element or the acceptor element is reduced and agglomerated, thereby causing a side effect. In addition, it may excessively deteriorate insulation properties or cause dielectric loss (tan δ).

The donor element A may be a substituent at a titanium (Ti) element site of titanium dioxide (TiO₂). In this case, the donor element A may mean a +5-valent element.

A According to some embodiments of the present disclosure, A may include at least one selected from the group consisting of Nb, Ta, Sb, Mo, and V. More preferably, A may include at least one of Nb or Ta. Even more preferably, A may include Nb.

The acceptor element B may be for a substituent at a titanium (Ti) element site of titanium dioxide (TiO₂). In this case, the acceptor element B may mean a +2-valent element or a +3-valent element.

According to some embodiments of the present disclosure, B may include at least one selected from the group consisting of Al, Ga, Mg, Zn, Sc, In, Yb, Er, and Eu. More preferably, B may include at least one of Al, Ga, or In. Even more preferably, B may include In.

A ratio of Am to Bm does not need to be specifically limited. For example, Am/Bm may satisfy 1.0≤Am/Bm≤2.0. Specifically, the number of moles of A substituted for the titanium (Ti) element site of titanium dioxide (TiO₂) may be 1.0 times or more and 2.0 times or less than the number of moles of B substituted for the titanium (Ti) element site of titanium dioxide (TiO₂). Therefore, permittivity of the dielectric layer 111 may be further improved, and a side effect may not occur.

In some embodiments, the dielectric layer 111 may have a mole number of Ti of 0.7 or more relative to a total mole number of elements excluding an oxygen element (O). This may be because the dielectric layer 111 may include TiO₂ doped with the donor element and the acceptor element, as a main component.

In some embodiments, the dielectric layer 111 may have a mole number of Ba of 0.1 or less relative to a total mole number of elements excluding an oxygen element (O). This may mean that the dielectric layer 111 is not formed of a conventional general barium titanate (BaTiO₃) dielectric material such as (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), or the like.

In some embodiments, the dielectric layer may have a mole number of Ca of 0.1 or less relative to a total mole number of elements excluding an oxygen element (O). This may mean that the dielectric layer 111 is not formed of a conventional general barium titanate (BaTiO₃) dielectric material, such as (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), or the like.

In some embodiments, the dielectric layer 111 may include (Ti_{1-x-y}AₓB_{y})O₂ (0<x<1, 0<y<1) as a main component. Therefore, by implementing a defect cluster, a higher permittivity may be implemented than a dielectric layer formed of a general barium titanate (BaTiO₃) dielectric material. In this case, the defect cluster may mean that a dipole is stabilized in a specific direction when a defect and an electron in a material interact with each other. In this case, the dielectric layer 111 may include (Ti_{1-x-y}NbₓIn_{y})O₂ (0<x<1, 0<y<1) as a main component. More preferably, the dielectric layer 111 may include (Ti_{1-x-y}NbₓIn_{y})O₂ (0<x<0.1, 0<y<0.1) as a main component.

In the present disclosure, the “main component” may mean a component occupying a relatively high weight ratio or a relatively high atomic number ratio compared to other components, and may mean a component exceeding 70 wt % based on a weight of the entire composition or the entire dielectric layer, a component exceeding 70 at % based on an atomic number, or a component exceeding 70 mol % based on a mole number.

In (Ti_{1-x-y}NbₓIn_{y})O₂, x and y may be limited such that the dielectric layer 111 satisfies that a mole number of Nb relative to 100 mol of Ti is more than 0.1 mol and 7.5 mol or less, and that a mole number of In relative to 100 mol of Ti is more than 0.1 mol and 7.5 mol or less.

In the present disclosure, as an example of a more specific method of measuring amounts of elements included in each component of the multilayer electronic component 100, a component may be analyzed using an energy dispersive X-ray spectroscopy (EDS) mode of a scanning electron microscope (SEM), an EDS mode of a transmission electron microscope (TEM), or an EDS mode of a scanning transmission electron microscope (STEM). First, a thinly sliced analysis sample may be prepared using a focused ion beam (FIB) device in an area to be measured. Then, a damaged layer on a surface of the thinned sample may be removed using xenon (Xe) or argon (Ar) ion milling, and then each component may be mapped in an image obtained using SEM-EDS, TEM-EDS, or STEM-EDS to proceed with qualitative/quantitative analysis. In this case, a graph for qualitative/quantitative analysis of each component may be expressed by converting the content of each element, for example, mass percentage (wt %), atomic percentage (at %), or mole percentage (mol %) of each element, and may also express the content of another specific component for the content of a specific component.

In another method, the chip may be pulverized to select an area to be measured, and a portion containing the selected dielectric microstructure may be analyzed using a device such as an inductively coupled plasma spectroscopy (ICP-OES), an inductively coupled plasma mass spectrometry (ICP-MS), or the like, for the area containing the selected dielectric microstructure.

In addition, a raw material forming the dielectric layer 111 may be added with various additives, organic solvents, binders, dispersants, or the like to the aforementioned dielectric material main component particles according to the purpose of the present disclosure.

Referring to FIG. 5, the dielectric layer 111 may include a central portion CP spaced apart from the internal electrode (121 and 122) and an interface portion (IP1 and IP2) disposed between the internal electrode (121 and 122) and the central portion CP, and a secondary phase 20 may be disposed in the interface portion (IP1 and IP2).

Therefore, the formation of secondary phase 20 can increase the resistance in the dielectric layer 111 by lowering an electron concentration in a dielectric crystal grain 11.

In addition, the formation of a secondary phase can reduce dielectric loss by suppressing the formation of oxygen-deficient TiO₂ (TiO₂₋ₓ, x<2), which can easily form at the interface portion (IP1 and IP2) and increases dielectric loss.

In some embodiments, the secondary phase 20 may include at least one of Ti or A.

When the secondary phase 20 includes A, e.g., in the secondary phase 20 including a donor element, an electron concentration in (Ti_{1-x-y}AₓB_{y})O₂ (0<x<1, 0<y<1) may be lowered to increase interfacial resistance of the dielectric crystal grains 11, thereby increasing resistance of the interface portion (IP1 and IP2).

When the secondary phase 20 includes Ti, e.g., in a Ti—O-based secondary phase 20, the dielectric loss in the dielectric layer 111 can be increased by suppressing an amount of oxygen-deficient TiO₂ (TiO₂₋ₓ, x<2) which can easily form at the interface portion (IP1 and IP2) and increases dielectric loss.

In some embodiments, the secondary phase 20 may include at least one of NbO₂, (Nb_{0.8} Ti_{0.2})O₂, Ti₂O, or Ti₆O. For example, the secondary phase 20 may include NbO₂ and (Nb_{0.8}Ti_{0.2})O₂, which may be a secondary phase containing a donor element, and may include Ti₂O and Ti₆O, which may be a metallic phase based on Ti—O.

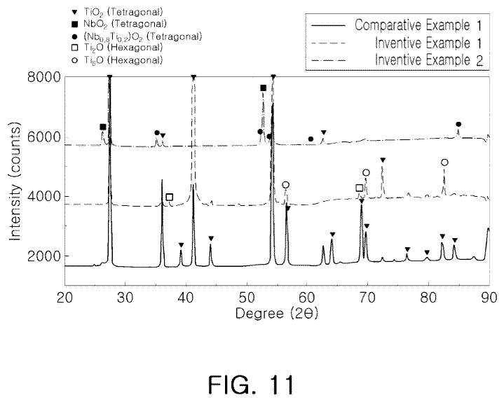

Referring to FIG. 11, which is X-ray diffraction (XRD) measurement results, it can be confirmed that, in Inventive Example 1, NbO₂ and (Nb_{0.8} Ti_{0.2})O₂, which may be a secondary phase containing a donor element, were detected, and in Inventive Example 2, Ti₂O and Ti₆O, which may be a metallic phase based on Ti, were detected.

In some embodiments, the central portion CP may not include the secondary phase 20, or the central portion CP may include the secondary phase 20, but an area fraction occupied by the secondary phase in the central portion CP may be smaller than an area fraction occupied by the secondary phase in the interface portion (IP1 and IP2). Therefore, permittivity may be further improved while dielectric loss may be reduced and resistivity may be increased.

For a specific example, the area fraction occupied by the secondary phase in the interface portion (IP1 and IP2) may be 10 times or more than the area fraction occupied by the secondary phase in the central portion CP.

Referring to FIG. 5, the dielectric layer 111 may include a plurality of dielectric crystal grains 11, crystal grain boundaries 12 disposed between dielectric crystal grains adjacent to each other, and an n-center 13 disposed at points in which three or more of the crystal grain boundaries are in contact, and the secondary phase 20 may be disposed at at least one interface between the dielectric layer 111 and the internal electrode (121 and 122), the crystal grain boundaries 12, and the n-center 13. Therefore, an electron concentration in the dielectric crystal grains 11 may be lowered to increase interface resistance of the dielectric crystal grains 11, resistance of the interface portion (IP1 and IP2) may be increased, or an amount of oxygen-deficient TiO₂ (TiO₂₋ₓ, x<2) that may be easily formed in the interface portion (IP1 and IP2) may be reduced to suppress a phase that increases dielectric loss.

In some embodiments, the dielectric layer may detect a resonance peak when measuring electron paramagnetic resonance (EPR).

Electron paramagnetic resonance (EPR) may be an experimental technique that analyzes magnetic properties of a material based on an electron spin state, and utilizes a principle that unshared electron spin in the material reacts to a strong magnetic field and a microwave of a specific frequency to cause a resonance phenomenon. EPR may identify the presence or absence of a trapped carrier in the material, and when a resonance peak is detected, it is considered that the trapped carrier exists. In this case, the trapped carrier may mean a trapped hole and a trapped electron, and the presence of trapped carrier in the dielectric layer may further improve permittivity. When the resonance peak is not detected, it is considered that there may be no trapped carrier because free radical does not exist, and in this case, it is difficult to improve permittivity. For example, in pure TiO₂ not doped with a donor element or an acceptor element, no resonance peak may be detected, which can be expected to be due to the absence of an electron-trapped peak caused by reduction behavior of Ti⁴⁺.

In some embodiments, the dielectric layer may detect a g-factor of greater than 1.95 and 2.004 or less when measuring electron paramagnetic resonance (EPR). Therefore, dielectric loss may be lowered while improving permittivity.

In the EPR measurement, a g-factor of 2.004 or less may indicate the presence of a trapped electron, and a g-factor of greater than 2.004 may indicate the presence of a trapped hole.

When a g-factor of 2.004 or less is detected in TiO₂ doped with a donor element or an acceptor element, it can be seen that the trapped electron may be formed in Ti ions, indicating the presence of Ti³⁺. For example, it indicates reduction behavior of Ti⁴⁺ due to electron trapping.

In some embodiments, the internal electrode (121 and 122) may include a first internal electrode 121 and a second internal electrode 122, alternately disposed with the dielectric layer 111 therebetween, and the interface portions (IP1 and IP2) may include a first interface portion IP1 disposed between the central portion CP and the first internal electrode 121, and a second interface portion IP2 disposed between the central portion CP and the second internal electrode 122. If an average thickness of the first interface portion IP1 is tdi1, an average thickness of the second interface portion IP2 is tdi2, and an average thickness of the central portion CP is tdc, tdi1/tdc≤0.2 and tdi2/tdc≤0.2 may be satisfied. Therefore, while improving permittivity, dielectric loss may be lowered and resistivity may be increased. For example, when the dielectric layer is divided into five areas in the thickness direction, since first and fifth areas may have a large effect on dielectric loss reduction and resistivity improvement effects, the first and fifth areas may be defined as the interface portion (IP1 and IP2).

A method of forming the dielectric layer 111 is not particularly limited.

For example, a ceramic slurry containing TiO₂ powder particles, a donor element, an acceptor element, an organic solvent, and a binder may be applied on a carrier film to prepare a ceramic green sheet, and then the ceramic green sheet may be sintered to form a dielectric layer. The donor element and the acceptor element may be added in a form of an oxide, and for example, Nb₂O₅ and In₂O₃ may be added to the ceramic slurry.

There may be no need to specifically limit a method for forming the secondary phase 20 in the interface portion (IP1 and IP2), and for example, additional heat treatment may be performed after the sintering process to selectively form the secondary phase 20 in the interface portion (IP1 and IP2). Specifically, the additional heat treatment may be performed at a high temperature of 1000° C. or higher within a short time of 10 minutes or less. However, it is not necessary to be limited thereto, and the secondary phase 20 may be selectively formed in the interface portion (IP1 and IP2) by controlling various conditions of the sintering process.

The body 110 may include a capacitance forming portion Ac in which capacitance is formed, including the first internal electrode 121 and the second internal electrode 122 disposed in the body 110 and disposed to face each other with the dielectric layer 111 interposed therebetween, and a cover portion (112 and 113) formed above and below the capacitance forming portion Ac in the first direction.

In addition, the capacitance forming portion Ac may be a portion that contributes to capacitance formation of the capacitor, and may be formed by repeatedly stacking a plurality of first and second internal electrodes 121 and 122 with the dielectric layer 111 therebetween.

The cover portion (112 and 113) may include an upper cover portion 112 disposed above the capacitance forming portion Ac in the first direction, and a lower cover portion 113 disposed below the capacitance forming portion Ac in the first direction.

The upper cover portion 112 and the lower cover portion 113 may be formed by stacking a single dielectric layer or two or more dielectric layers on upper and lower surfaces of the capacitance forming portion Ac in the thickness direction, respectively, and may basically play a role in preventing damage to the internal electrode due to physical or chemical stress.

The upper cover portion 112 and the lower cover portion 113 may not include the internal electrode, and may include the same material as the dielectric layer 111.

For example, the upper cover portion 112 and the lower cover portion 113 may include a ceramic material, and for example, the cover portion (112 and 113) may include (Ti_{1-x-y}AₓB_{y})O₂ (0<x<1, 0<y<1) as a main component. However, it is not limited thereto, and the cover portion (112 and 113) may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and/or Ba(Ti_{1-y}Zr_{y})O₃ (0<y<1) as a main component. For example, the cover portion may be formed using a ceramic green sheet different from a ceramic green sheet for forming the dielectric layer of the capacitance forming portion.

A thickness of the cover portion (112 and 113) does not need to be particularly limited. To more easily achieve miniaturization and high capacity of the multilayer electronic component, a thickness tc of the cover portion (112 and 113) may be 15 μm or less.

An average thickness tc of the cover portion (112 and 113) may mean a size in the first direction, and may be an average value of sizes in the first direction of the cover portion (112 and 113) measured at five points at equal intervals above or below the capacitance forming portion Ac.

In addition, a margin portion (114 and 115) may be disposed on the side of the capacitance forming portion Ac.

The margin portion (114 and 115) may include a first margin portion 114 disposed on the fifth surface 5 of the body 110, and a second margin portion 115 disposed on the sixth surface 6. For example, the margin portions 114 and 115 may be disposed on both end surfaces of the ceramic body 110 in the width direction.

As illustrated in FIG. 3, the margin portion (114 and 115) may mean an area between both ends of the first and second internal electrode (121 and 122) and a boundary surface of the body 110 in the cross-section of the body 110 cut in the width-thickness (W-T or X-Z) direction.

The margin portion (114 and 115) may basically play a role in preventing damage to the internal electrode due to physical or chemical stress.

The margin portion (114 and 115) may be formed by forming the internal electrode by applying a conductive paste, except for an area in which the margin portion is formed on the ceramic green sheet. In this case, the margin portion (114 and 115) may have TiO₂ as a main component.

In addition, to suppress a step difference by the internal electrode (121 and 122), when the internal electrode is cut to exposed to the fifth and sixth surfaces 5 and 6 of the body after stacking, and then a single dielectric layer or two or more dielectric layers are stacked on both side surfaces of the capacitance forming portion Ac in the third direction (width direction) to form the margin portions 114 and 115. In this case, the margin portion (114 and 115) may include TiO₂ as a main component, or may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and/or Ba(Ti_{1-y}Zr_{y})O₃ (0<y<1) as a main component.

A width of the margin portion (114 and 115) does not need to be specifically limited. To more easily achieve miniaturization and high capacity of the multilayer electronic component, an average width of the margin portion (114 and 115) may be 15 μm or less.

The average width of the margin portion (114 and 115) may mean a third direction average size MW1 of an area in which the internal electrode is spaced apart from the fifth surface, and a third direction average size (MW2) of an area in which the internal electrode is spaced apart from the sixth surface, and may be an average value of third direction sizes of the margin portion (114 and 115) measured at five equally spaced points on a side surface of the capacitance forming portion Ac.

Therefore, in an embodiment, the third direction average sizes MW1 and MW2 of areas in which the internal electrodes 121 and 122 are spaced apart from the fifth and sixth surfaces may be 15 μm or less, respectively.

The internal electrode (121 and 122) may include first and second internal electrodes 121 and 122. The first and second internal electrodes 121 and 122 may be alternately disposed to face each other, with the dielectric layer 111 forming the body 110 interposed therebetween, and may be exposed to the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body and connected to the first internal electrode 121, and a second external electrode 132 may be disposed on the fourth surface 4 of the body and connected to the second internal electrode 122.

For example, the first internal electrode 121 may not be connected to the second external electrode 132, but may be connected to the first external electrode 131, and the second internal electrode 122 may not be connected to the first external electrode 131, but may be connected to the second external electrode 132. Therefore, the first internal electrode 121 may be formed at a predetermined distance from the fourth surface 4, and the second internal electrode 122 may be formed at a predetermined distance from the third surface 3. In addition, the first and second internal electrode (121 and 122) may be disposed at a predetermined distance from the fifth and sixth surfaces of the body 110.

A conductive metal included in the internal electrode (121 and 122) may be one or more selected from the group consisting of Ni, Cu, Pd, Ag, Au, Pt, In, Sn, Al, W, Ti, and alloys thereof, and the present disclosure is not limited thereto.

An average thickness td of the dielectric layer 111 does not need to be particularly limited, but may be, for example, 0.1 μm to 10 μm. An average thickness the of the internal electrode (121 and 122) does not need to be particularly limited, but may be, for example, 0.05 μm to 3.0 μm. In addition, the average thickness td of the dielectric layer 111 and the average thickness the of the internal electrode (121 and 122) may be arbitrarily set according to desired characteristics or purposes. For example, in high-voltage electric/electronic components, to achieve miniaturization and high capacity, the average thickness td of the dielectric layer 111 may be less than 2.8 μm, and the average thickness the of the internal electrode (121 and 122) may be less than 1 μm. In addition, to achieve miniaturization and high capacity, for small IT electronic components, the average thickness td of the dielectric layer 111 may be 0.4 μm or less, and the average thickness the of the internal electrode (121 and 122) may be 0.4 μm or less.

The average thickness td of the dielectric layer 111 and the average thickness the of the internal electrode (121 and 122) represent first direction sizes of the dielectric layer 111 and the internal electrode (121 and 122), respectively. The average thickness td of the dielectric layer 111 and the average thickness the of the internal electrode (121 and 122) may be measured by scanning first direction and second direction cross-sections of the body 110 with a scanning electron microscope (SEM) at 10,000 times magnification. More specifically, the average thickness td of the dielectric layer 111 may be determined by measuring thicknesses at a plurality of points of one dielectric layer 111, for example, 30 points equally spaced in the second direction, and measuring the average value. In addition, the average thickness the of the internal electrode (121 and 122) may be determined by measuring thicknesses at a plurality of points of one internal electrode (121 and 122), for example, 30 points equally spaced in the second direction, and measuring the average value. The 30 equally spaced points may be designated in the capacitance forming portion Ac. when such average value measurements may be performed for each of 10 dielectric layers 111 and 10 internal electrode (121 and 122), and then the average value may be measured, the average thickness td of the dielectric layer 111 and the average thickness the of the internal electrode (121 and 122) may be further generalized. The external electrodes 131 and 132 may be disposed on the third surface 3 and the fourth surface 4 of the body 110.

The external electrodes 131 and 132 may be disposed on the third and fourth surfaces 3 and 4 of the body 110, respectively, and may include first and second external electrodes 131 and 132 connected to the first and second internal electrodes 121 and 122, respectively.

Referring to FIG. 1, the external electrodes 131 and 132 may be disposed to cover both end surfaces of the side margin portions 114 and 115 in the second direction.

In this embodiment, a structure in which a multilayer electronic component 100 has two external electrodes (131 and 132) may be described, but the number or shapes of the external electrodes 131 and 132 may be changed depending on a shape of the internal electrode (121 and 122) or other purposes.

The external electrodes 131 and 132 may be formed of any material as long as they have electrical conductivity, such as metal or the like, and a specific material may be determined in consideration of electrical characteristics, structural stability, or the like, and may further have a multilayer structure.

For example, the external electrodes 131 and 132 may include electrode layers 131a and 132a disposed on the body 110, and plating layers 131b and 132b disposed on the electrode layers 131a and 132a, respectively.

As a more specific example of the electrode layers 131a and 132a, the electrode layers 131a and 132a may be fired electrodes including a conductive metal and glass or resin-based electrodes including a conductive metal and a resin.

In addition, the electrode layers 131a and 132a may have a form in which the sintered electrode and the resin-based electrode are sequentially formed on the body 110. In addition, the electrode layers 131a and 132a may be formed by transferring a sheet containing the conductive metal onto the body 110, or may be formed by transferring a sheet containing the conductive metal onto the sintered electrode.

As the conductive metal used for the electrode layers 131a and 132a, a material that may be electrically connected to the internal electrode (121 and 122) to form capacitance may be used, but is not particularly limited thereto. For example, the conductive metal may include one or more selected from the group consisting of nickel (Ni), copper (Cu), and alloys thereof.

The plating layer (131b and 132b) may serve to improve mounting characteristics. A type of the plating layer (131b and 132b) is not particularly limited, may be provided as a single plating layer (131b and 132b) containing at least one of nickel (Ni), tin (Sn), palladium (Pd), or an alloy thereof, and may be formed as a plurality of layers.

For a more specific example of the plating layer (131b and 132b), the plating layer (131b and 132b) may be an Ni plating layer or an Sn plating layer, and the Ni plating layer and the Sn plating layer may be sequentially formed on the electrode layer (131a and 132a). The Sn plating layer, the Ni plating layer, and the Sn plating layer may be sequentially formed. In addition, the plating layer (131b and 132b) may include a plurality of Ni plating layers and/or a plurality of Sn plating layers.

A size of the multilayer electronic component 100 need not be particularly limited. For example, a size of the multilayer electronic component 100 may be 0201 (length×width, 0.2 mm×0.1 mm), 0603 (length×width, 0.6 mm×0.3 mm), 1005 (length×width, 1.0 mm×0.5 mm), or the like.

### Method of Manufacturing Multilayer Electronic Component

Hereinafter, an example of a method for manufacturing a multilayer electronic component 100 according to an embodiment of the present disclosure will be described. The method for manufacturing a multilayer electronic component 100 of the present disclosure is not limited thereto.

First, a ceramic slurry containing TiO₂ powder particles, a donor element, an acceptor element, an organic solvent, and a binder may be applied on a carrier film to prepare a ceramic green sheet. The donor element and the acceptor element may be added in a form of an oxide, and for example, Nb₂O₅ and In₂O₃ may be added to the ceramic slurry.

Afterwards, a conductive paste for internal electrodes containing metal powder particles, a binder, an organic solvent, or the like may be printed on the ceramic green sheet with a predetermined thickness using a screen printing method, a gravure printing method, or the like, to form an internal electrode pattern, thereby manufacturing a ceramic green sheet for a capacity forming portion.

The ceramic green sheets for the capacity forming portion may be stacked in the X-direction to obtain a stack body. In this case, ceramic green sheets on which the internal electrode pattern is not formed may be stacked above and below the stack body to form a cover portion (112 and 113) after sintering.

Then, the stack body may be cut to have a predetermined chip size to obtain a unit stack body.

Afterwards, after sintering the unit stack body, a secondary phase 20 may be formed in an interface portion (IP1 and IP2) through additional heat treatment. Specifically, the additional heat treatment may be performed at a high temperature of 1000° C. or higher within a short time of 10 minutes or less. However, it is not necessary to be limited thereto, and the secondary phase 20 may be selectively formed in the interface portion (IP1 and IP2) by controlling various conditions of the sintering process.

Next, an external electrode (131 and 132) may be formed. For example, when a basic electrode layer (131a and 132a) include a sintered electrode layer, a body 110 may be dipped in a conductive paste for an external electrode including a metal powder, a glass frit, a binder, and an organic solvent, and then the conductive paste for an external electrode may be sintered at a temperature of 500° C. to 900° C. to form a sintered electrode layer.

For example, when the basic electrode layer (131a and 132a) include a resin electrode layer, the body may be dipped in a conductive resin composition including a metal powder, a resin, a binder, and an organic solvent, and then the resin electrode layer may be formed by performing curing heat treatment at a temperature of 250° C. to 550° C. In addition, electrolytic plating and/or electroless plating may be additionally performed to form a plating layer (131b and 132b) on the basic electrode layer (131a and 132a).

### Experimental Example

A ceramic slurry containing TiO₂ powder particles, Nb₂O₅, In₂O₃, an organic solvent, and a binder was applied onto a carrier film to prepare a ceramic green sheet. In this case, 5 moles of Nb₂O₅ and 5 moles of In₂O₃ relative to 100 moles of TiO₂ were added.

Thereafter, Comparative Example 1 and Comparative Example 3 performed a sintering process at 1350° C. for 10 hours, Comparative Example 2 performed a sintering process at 1450° C. for 10 hours, and Inventive Example 1 performed a sintering process at 1350° C. for 10 hours and then performed an additional heat treatment at 1450° C. for 30 seconds.

Afterwards, a X-ray photoelectron spectroscopy (XPS) measurement was performed on Comparative Example 1, Comparative Example 2, and Inventive Example 1, to analyze whether oxygen vacancy was formed.

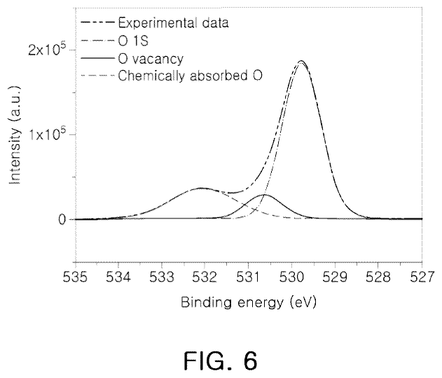

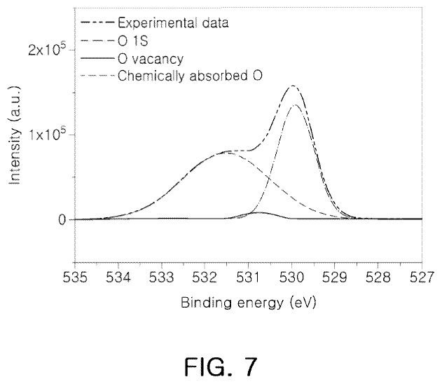

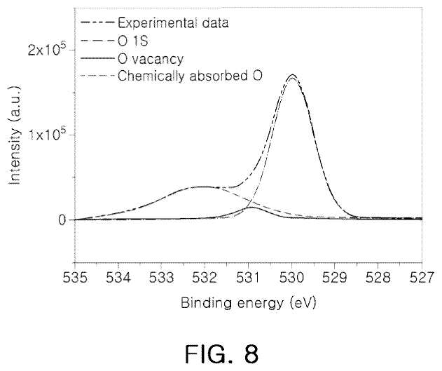

FIG. 6 is a graph illustrating the X-ray photoelectron spectroscopy (XPS) measurement results of Comparative Example 1, FIG. 7 is a graph illustrating XPS measurement results of Comparative Example 2, and FIG. 8 is a graph illustrating the XPS measurement results of Inventive Example 1. In this case, Al Kα (1486.6 eV) was used as an X-ray light source.

In FIGS. 6 to 8, a shoulder peak having a higher binding energy to the left of an O1S peak may mean an oxygen vacancy peak, and a chemically absorbed oxygen peak that may be induced on a surface due to formation of oxygen vacancy, respectively.

Referring to FIG. 6, it can be confirmed that, in Comparative Example 1, a shoulder peak for an O1S peak is formed, and oxygen vacancy necessary for improving permittivity (implementing a large permittivity) is formed.

Referring to FIG. 7, it can be confirmed that, in Comparative Example 2, a sintering temperature increases, such that bonding between Ti—O on a surface is easily broken, and oxygen vacancy is formed more easily, and a higher shoulder peak is formed.

Referring to FIG. 8, it can be observed that a height of a shoulder peak relative to an O1s peak in Inventive Example 1 is higher than in Comparative Example 1. This may mean that the oxygen vacancy has increased compared to Comparative Example 1, and it can be expected that a change in defect state on surface has changed compared to Comparative Example 1 due to additional heat treatment.

Through FIGS. 6 to 8, it can be confirmed that Comparative Example 1, Comparative Example 2, and Inventive Example 1 all have oxygen vacancy, although amounts of oxygen vacancy are different.

For example, Comparative Example 1, Comparative Example 2, and Inventive Example 1 all have oxygen vacancy, which may be a defect for implementing a defect cluster.

Afterwards, electron paramagnetic resonance (EPR) measurement was performed to determine whether an electron-trapped defect cluster was formed. When measuring EPR, a g-factor of 2.004 or less indicates the presence of a trapped electron, and a g-factor of more than 2.004 indicates the presence of a trapped hole. In addition, when there is no resonance peak, it is considered that there is no trapped carrier because there is no free radical.

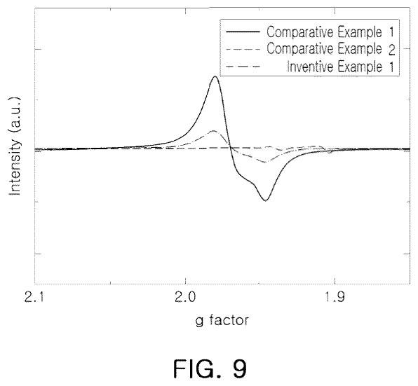

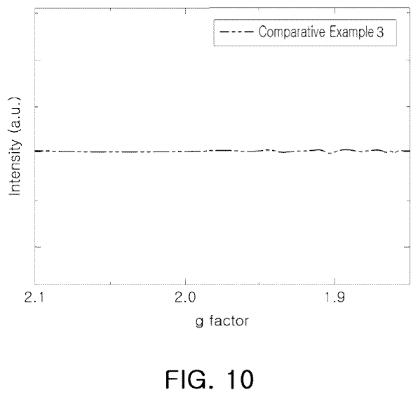

FIG. 9 is a graph illustrating electron paramagnetic resonance (EPR) measurement results of Comparative Example 1, Comparative Example 2, and Inventive Example 1. FIG. 10 is a graph illustrating EPR measurement results of Comparative Example 3.

Referring to FIG. 10, in Comparative Example 3, no resonance peak is detected as pure TiO₂ without doping a donor element or an acceptor element, which can be expected to be due to the absence of an electron-trapped peak caused by reduction behavior of Ti⁴⁺, and it can be confirmed that it is difficult to implement an electron-trapped defect cluster.

Referring to FIG. 9, in Comparative Example 2, similar to Comparative Example 3, no resonance peak can be observed, and it can be seen that no trapped electron exists. Therefore, it can be confirmed that it is difficult to implement a defect cluster in Comparative Example 2 as well.

Since Inventive Example 1 and Comparative Example 1 have a g-factor of 2.004 or less, it can be confirmed that a trapped electron exists, and it can be confirmed that Ti³⁺ exists in a material. The g-factors of Inventive Example 1 and Comparative Example 1 can be observed at 1.95 and 1.97, respectively, but it can be confirmed that an intensity of Comparative Example 1 is greater than an intensity of Inventive Example 1.

In Inventive Example 1, since additional heat treatment was performed compared to Comparative Example 1, it can be expected that a resonance signal decreases and a trapped electron decreases, but a Ti³⁺ peak was still observed at the same g-factor position, confirming the presence of the trapped electron. Therefore, it can be confirmed that an electron-trapped defect cluster was implemented in Inventive Example 1.

FIG. 11 is a graph illustrating X-ray diffraction (XRD) measurement results of Comparative Example 1, Inventive Example 1, and Inventive Example 2. In Inventive Example 2, unlike Inventive Example 1, additional heat treatment was performed for 10 minutes, and all other conditions were the same.

In Comparative Example 1, it can be confirmed that a secondary phase such as NbO₂, (Nb_{0.8}Ti_{0.2})O₂, Ti₂O, Ti₆O, or the like is not detected, and only a TiO₂ phase is detected. In general, when a dopant is uniformly dissolved in a parent material, since only a parent material phase exists, and a secondary phase does not exist, a secondary phase peak may not be detected in XRD measurement results. For example, when an Nb donor and an In acceptor are dissolved in a TiO₂ parent material, only a TiO₂ phase may be detected in XRD measurement results.

In Inventive Example 1, a Ti—O-based metallic phase of Ti₂O and Ti₆O was detected as a secondary phase. The Ti—O-based metallic phase may easily express a reaction that breaks the Ti—O bonding during sintering on a surface, such that oxygen-deficient TiO₂ (TiO₂₋ₓ, x<2) causing high dielectric loss may be reduced. Therefore, stable dielectric loss and resistivity values can be induced.

In Inventive Example 2, it can be confirmed that NbO₂ and (Nb_{0.8}Ti_{0.2})O₂, which are secondary phases containing a donor element, were detected as a secondary phase. The secondary phase containing the donor element is eluted from a sintered body, and lowers a degree of solidification of the donor element for the sintered body, so the number of free electrons existing in the sintered body may be reduced. Therefore, stable dielectric loss and resistivity values can be induced.

Table 1 below shows permittivity, DF, and resistivity measured for sample chips of Comparative Example 1, Comparative Example 2, and Inventive Example 1. An LCR meter was connected to both electrodes of each of the sample chips to measure the permittivity. The permittivity was obtained by considering and converting a thickness and an area structure of a dielectric portion in the chips from a capacitance value obtained by the LCR meter. Capacitance was measured under conditions of 1 Vrms, 25° C., and 1 kHz (measurement frequency), but the same evaluation may be made with other permittivity measurement equipment and conditions. DF (%) means dielectric loss, and was measured using the same equipment and method as the permittivity measurement.

The resistivity (Ω·cm) was measured at a humidity of 50% or less by connecting a multimeter to both electrodes of each of the sample chips, and a measured resistance value was obtained by considering and converting the thickness and the area structure of the dielectric portion in the chips.

TABLE 1

| | Comparative | Comparative | Inventive |
|---|---|---|---|
| Test No. | Example 1 | Example 2 | Example 1 |
| Permittivity | 13065 | 141 | 11065 |
| DF | 8.9% | 3.0% | 5.0% |
| Resistivity | 2.34*10⁷ | 4.52*10¹² | 1.28*10¹¹ |
| (Ω · cm) | | | |

Referring to Table 1, it can be confirmed that, in Comparative Example 1, high permittivity is implemented, but high dielectric loss (DF) and low resistivity are achieved. In Comparative Example 2, low dielectric loss and high resistivity are achieved, but low permittivity is achieved.

In Inventive Example 1, it can be confirmed that high permittivity is implemented, but low dielectric loss and high resistivity are achieved.

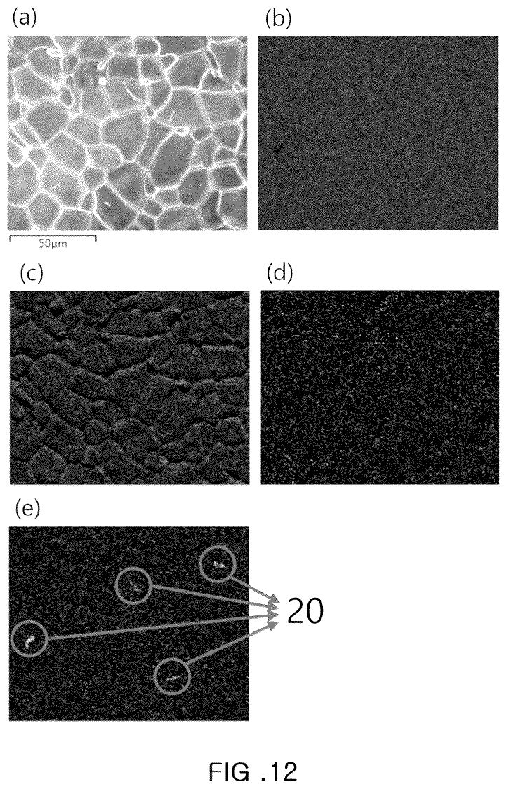

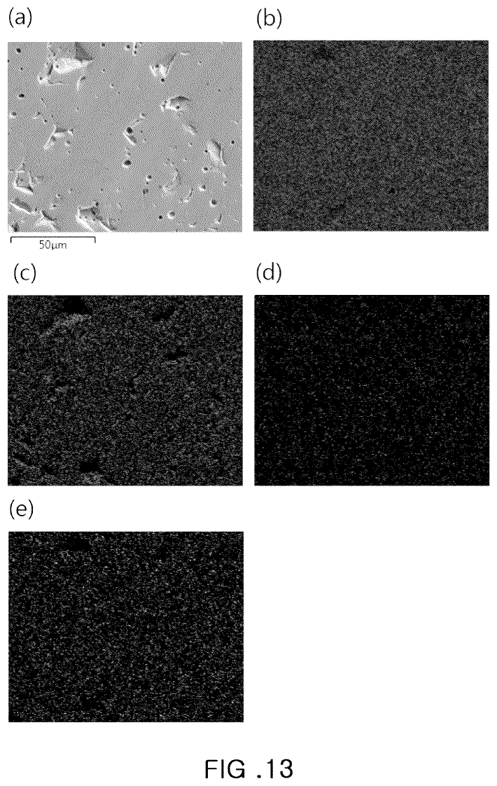

FIG. 12 is an image illustrating an interface of a dielectric layer of Inventive Example 2 analyzed by SEM-EDS. FIG. 13 is an image illustrating a central portion of a dielectric layer of Inventive Example 2 analyzed by SEM-EDS.

In FIGS. 12 and 13, portion (a) is an image scanned by SEM, portion (b) is an image of Ti analyzed by EDS in the same area, portion (c) is an image of O analyzed by EDS in the same area, portion (d) is an image of In analyzed by EDS in the same area, and portion (e) is an image of Nb analyzed by EDS in the same area.

Referring to FIGS. 12 and 13, it can be confirmed that a Nb-based secondary phase 20 is formed in an area in which a concentration of an Nb element is high at an interface of a dielectric layer, but it can be confirmed that Nb is uniformly distributed in a central portion of the dielectric layer, such that the secondary phase is not formed.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

As an effect of the present disclosure, a secondary phase including at least one of Ti or A may be disposed in an interface portion of a dielectric layer including Ti, A as a donor element, and B as an acceptor element, to secure high permittivity.

As an effect of the present disclosure, a multilayer electronic component having low dielectric loss may be provided.

As an effect of the present disclosure, a multilayer electronic component having high resistivity may be provided.

Various advantages and effects of the present disclosure are not limited to the above-described contents, and will be more easily understood in a process of explaining specific embodiments of the present disclosure.

While example embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including a dielectric layer and an internal electrode; and
an external electrode disposed on the body,
wherein the dielectric layer includes Ti, A as a donor element, and B as an acceptor element,
wherein the dielectric layer satisfies 0.1<Am≤7.5 and 0.1<Bm≤7.5, where Am and Bm are a number of moles of A and a number of moles of B, relative to 100 moles of Ti included in the dielectric layer, respectively,
wherein the dielectric layer includes: a central portion spaced apart from the internal electrode; an interface portion disposed between the internal electrode and the central portion, and
wherein the interface portion includes a secondary phase including at least one of Ti or A.

2. The multilayer electronic component of claim 1, wherein the central portion does not include the secondary phase.

3. The multilayer electronic component of claim 1, wherein the central portion includes the secondary phase, and an area fraction occupied by the secondary phase in the central portion is smaller than an area fraction occupied by the secondary phase in the interface portion.

4. The multilayer electronic component of claim 1, wherein the dielectric layer includes a plurality of dielectric crystal grains, crystal grain boundaries disposed between the dielectric crystal grains adjacent to each other, and an n-center disposed at points in which three or more of the crystal grain boundaries meet, and
the secondary phase is disposed at at least one of an interface between the dielectric layer and the internal electrode, the crystal grain boundaries, or the n-center.

5. The multilayer electronic component of claim 1, wherein the dielectric layer includes (Ti_{1-x-y}AₓB_{y})O₂ (0<x<0.1, 0<y<0.1) as a main component.

6. The multilayer electronic component of claim 1, wherein Am and Bm satisfy 0.2<Am+Bm≤15.0.

7. The multilayer electronic component of claim 1, wherein Am and Bm satisfy 1.0≤Am/Bm≤2.0.

8. The multilayer electronic component of claim 1, wherein A includes at least one of Nb, Ta, Sb, Mo, or V.

9. The multilayer electronic component of claim 1, wherein the dielectric layer includes 0.7 mole or more of Ti relative to a total mole number of elements in the dielectric layer excluding an oxygen element (O).

10. The multilayer electronic component of claim 1, wherein the dielectric layer includes 0.1 mole or less of Ba relative to a total mole number of elements in the dielectric layer excluding an oxygen element (O).

11. The multilayer electronic component of claim 1, wherein the dielectric layer includes 0.1 mole or less of Ca relative to a total mole number of elements in the dielectric layer excluding an oxygen element (O).

12. The multilayer electronic component of claim 1, wherein the secondary phase includes at least one of NbO₂ or (Nb_{0.8}Ti_{0.2})O₂.

13. The multilayer electronic component of claim 1, wherein the secondary phase includes at least one of Ti₂O or Ti₆O.

14. The multilayer electronic component of claim 1, wherein, in the dielectric layer, a resonance peak is detected when measuring electron paramagnetic resonance (EPR).

15. The multilayer electronic component of claim 1, wherein, in the dielectric layer, a g-factor of 2.004 or less is detected when measuring electron paramagnetic resonance (EPR).

16. The multilayer electronic component of claim 1, wherein the internal electrode includes a first internal electrode and a second internal electrode, alternately disposed with the dielectric layer interposed therebetween, and
the interface portion includes a first interface portion disposed between the central portion and the first internal electrode and a second interface portion disposed between the central portion and the second internal electrode,
wherein the dielectric layer satisfies tdi1/tdc≤0.2 and tdi2/tdc≤0.2, where an average thickness of the first interface portion is tdi1, an average thickness of the second interface portion is tdi2, and an average thickness of the central portion is tdc.

17. A multilayer electronic component comprising:
a body including a dielectric layer and an internal electrode; and
an external electrode disposed on the body,
wherein the dielectric layer includes (Ti_{1-x-y}NbₓIn_{y})O₂ (0<x<0.1, 0<y<0.1) as a main component, and a central portion spaced apart from the internal electrode and an interface portion disposed between the internal electrode and the central portion,
wherein the interface portion includes a secondary phase, and
wherein the secondary phase includes at least one of NbO₂ or (Nb_{0.8}Ti_{0.2})O₂.

18. The multilayer electronic component of claim 17, wherein the secondary phase includes at least one of Ti₂O or Ti₆O

19. The multilayer electronic component of claim 17, wherein the central portion does not include the secondary phase.

20. The multilayer electronic component of claim 17, wherein the central portion includes the secondary phase, and an area fraction occupied by the secondary phase in the central portion is smaller than an area fraction occupied by the secondary phase in the interface portion.
